(19) United States
(12) Patent Application Publication
(10) Pub. No.: US 2005/0269863 A1
(43) Pub. Date: Dec. 8, 2005

(54) Wheel cover retention clip

(76) Inventor: Gregory R. Hauler, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/201,016

(22) Filed: Aug. 10, 2005

Related U.S. Application Data
(62) Division of application No. 10/757,675, filed on Jan. 14, 2004.

(51) Int. Cl. B60B 7/10

(52) U.S. Cl. 301/37.35

(57) ABSTRACT

A wheel cover assembly includes a cover member having an inner surface, an outer surface, a body portion, and a skirt portion extending inwardly from and circumferentially about the body portion. The wheel cover assembly also includes at least one retention clip operably coupled with the cover member and having leg portion and an engagement portion extending outwardly from the leg portion, wherein the leg portion abuts the inner surface of the skirt portion along a length of the leg portion, and wherein the engagement portion is adapted to abut a lug nut of a wheel assembly, thereby releasably coupling the wheel cover assembly with the wheel assembly.

### CROSS-REFERENCE TO RELATED APPLICATION

This application is a divisional of U.S. patent application Ser. No. 10/757,675, filed Jan. 14, 2005, entitled WHEEL COVER RETENTION CLIP, the entire disclosure of which is incorporated herein by reference.

### BACKGROUND OF THE INVENTION

The present invention relates to vehicle wheels, and particularly to a wheel cover retention clip for operably coupling a wheel cover or cap to an associated vehicle wheel.

Ornamental outer coverings have been employed for providing a decorative surface to the exposed surface of a vehicle wheel for many years. These outer coverings offer design flexibility and various configurations that may be used to cover a single style wheel. In certain applications, the ornamental wheel covering is constructed of a polymeric material or plastic that is then coated with a metal plating. U.S. Pat. Nos. 5,564,791; 5,577,809; 5,597,213; 5,630,654; 5,636,906; 5,845,973; and, 6,085,829, the disclosures of which are incorporated herein by reference, represent different approaches for providing and attaching such cladding to existing wheels to provide a decorative appearing wheel.

Heretofore, various configurations of attachment clips have been used to attach the aesthetic wheel covers to the associated wheels. Typically, these attachment clips are configured to work with a cover and/or a wheel of a single configuration, thereby limiting the utility of the particular clip and requiring clips of various designs to be used as the layout of the cover and/or wheel are altered. These changes to the wheel and/or wheel cover configuration may be as straightforward as altering the lug nut orientation or layout, i.e., a four-lug wheel as compared to a five-lug wheel, but may still require a complete redesign to the attachment clip. Further, many of these attachment clips are configured so as to be useful only with wheel covers that completely cover the lug nuts as associated with the vehicle wheels, making them unusable with various designs of wheel covers that allow the lug nuts to remain exposed subsequent to the wheel cover being attached to the associated vehicle wheel.

A retention clip is desired that is usable between a variety of wheel covers and vehicle wheel configurations, and that is adapted for use with wheel cover configurations that allow access to lug nuts as associated with the vehicle wheel subsequent to the wheel cover being attached to the vehicle wheel.

### SUMMARY OF THE INVENTION

One aspect of the present invention is to provide a wheel cover assembly that includes a cover member having an inner surface, an outer surface, a body portion, and a skirt portion extending inwardly from and circumferentially about the body portion. The wheel cover assembly also includes at least one retention clip operably coupled with the cover member and having a leg portion and an engagement portion extending outwardly from the leg portion, wherein the leg portion abuts the inner surface of the skirt portion along a length of the leg portion, and wherein the engagement portion is adapted to abut a lug nut of a wheel assembly, thereby releasably coupling the wheel cover assembly with the wheel assembly.

Another aspect of the present invention is to provide a retention clip for a vehicle wheel cover member that includes a flexibly resilient U-shaped portion adapted to engage a wall of a vehicle wheel cover member, and a leg portion extending from the U-shaped portion and cooperating with the U-shaped portion to form an S-shape, wherein the leg portion is adapted to abut the cover member along a length of the leg portion when the retention clip is operably coupled with the cover member. The retention clip further includes an engagement portion extending from the leg portion, and adapted to engage a vehicle wheel, thereby.coupling the cover member with the vehicle wheel.

Yet another aspect of the present invention is to provide a wheel cover assembly that includes a cover member having an inner surface, and outer surface, and at least one boss extending inwardly from the inner surface, wherein the cover member is configured such that lug nuts of the associated vehicle wheel assembly remain exposed when the cover member is coupled with the vehicle wheel assembly. The wheel cover assembly also includes at least one retention clip having a body portion with at least one aperture extending therethrough and frictionally receiving the at least one boss of the cover member therein, thereby coupling the at least one retention clip to the cover member, at least one leg portion extending from the body portion, and at least one engagement portion extending from the at least one leg portion, wherein the at least one engagement portion extends outwardly beyond the outer surface of the cover member and is adapted to engage the vehicle wheel assembly, thereby coupling the cover member with the vehicle wheel assembly.

Still yet another aspect of the present invention is to provide a retention clip for a vehicle wheel cover member that includes a body portion having an aperture extending therethrough and adapted to frictionally receive a boss of a vehicle wheel cover member therein, thereby coupling the retention clip to the cover member. The retention clip also includes a leg portion extending from the body portion, and an engagement portion extending from the leg portion. The engagement portion is adapted to extend outwardly beyond an outer surface of the cover member and to engage a vehicle wheel assembly, thereby coupling the cover member with the vehicle wheel assembly such that a plurality of lug nuts of the vehicle wheel assembly are exposed when the cover member is coupled with the vehicle wheel assembly.

The retention clip as disclosed and described herein is useable between a variety of wheel cover and vehicle wheel configurations, and is useable with wheel cover configurations that allow access to lug nuts as associated with the vehicle wheel subsequent to the wheel cover being coupled with the vehicle wheel. The retention clip as disclosed herein reduces manufacturing costs as associated with the necessity for manufacturing retention clips of various designs in order to adequately retain wheel covers with vehicle wheels each having varying configurations. The retention clip may be assembled with the associated wheel coverings without the requirement of complicated or specialized tools, may be easily and quickly assembled by even unskilled personnel, is capable of a long operating life, and is particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a wheel assembly;

FIG. 2 is an exploded perspective view of the wheel assembly that includes a first embodiment of a retainer clip embodying the present invention;

FIG. 3 is a perspective view of a wheel cover assembly;

FIG. 4 is a perspective view of the first embodiment of the retainer clip;

FIG. 5 is a cross-sectional view of the wheel cover assembly coupled with a vehicle wheel assembly;

FIG. 6 is a perspective view of the wheel cover and a second embodiment of the retainer clip;

FIG. 7 is a perspective view of the second embodiment of the retainer clip;

FIG. 8 is a cross-sectional view of the wheel cover including the second embodiment of the retainer clip assembled with the wheel assembly;

FIG. 9 is a perspective view of the wheel cover assembly including a third embodiment of the retainer clip;

FIG. 10 is a perspective view of the third embodiment of the retainer clip; and

FIG. 11 is a cross-sectional view of the wheel cover assembly including the third embodiment of the retainer clip.

### DETAILED DESCRIPTION OF THE PREFERRED EMBODIMENTS

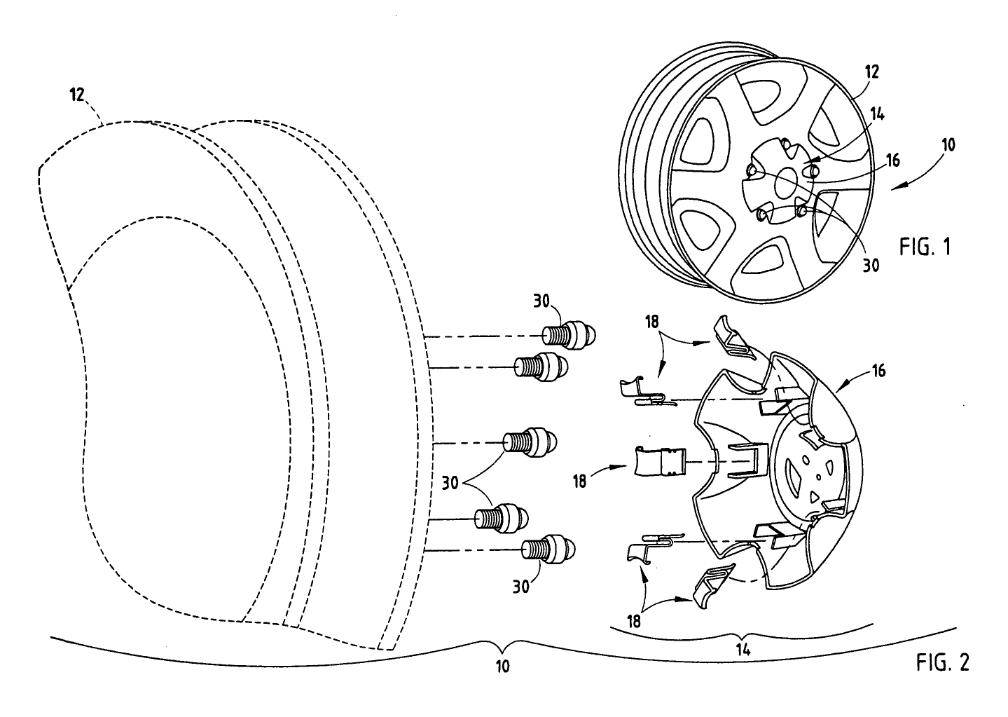

For purposes of description herein, the terms “upper,” “lower,” “right,” “left,” “rear,” “front,” “vertical,” “horizontal,” and derivatives thereof shall relate to the invention as oriented in FIGS. 1-3, 6 and 9. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIGS. 1 and 2) generally designates a vehicle wheel assembly that includes a vehicle wheel 12 and a wheel cover assembly 14. The wheel cover assembly 14 includes a wheel cover 16 and a plurality of retainer clips 18 that releasably secure the wheel cover 16 to the wheel 12.

In the illustrated example, the wheel cover 16 of the wheel cover assembly 14 is substantially bowl-shaped and includes an inner surface 20, an outer surface 22, a body portion 24 and a skirt portion 26 extending inwardly from and circumferentially about the body portion 24. The outer surface 22 of the wheel cover 16 is typically provided with an ornamental outer covering such as a layer of metal plating. The skirt portion 26 includes a plurality of recesses 28 spaced circumferentially about an outer periphery of the wheel cover 16 and adapted so as to allow access to a plurality of lug nuts 30 associated with the wheel 12 when the wheel cover assembly 14 is coupled with the wheel 12, as described below. Each recess 28 includes a notch 29 located within a rim thereof for receiving a portion of a retainer clip 18 therein, as described below. The wheel cover 16 further includes a plurality of sleeves 32 coaligned with the recesses 28 and each including an inner wall 34 spaced apart from the skirt portion 26 so as to create a pocket 35 therebetween, and a pair of sidewalls 36 opposed across the inner wall 34 and extending inwardly from the inner surface of the wheel cover 16, thereby structurally supporting the inner wall 34. Preferably, the body portion 24, the skirt portion 26 and the sleeves 32 are integrally formed as a single piece. The wheel cover 16 is preferably constructed of a polymeric material or plastic that is then coated with a metal plating, however, other suitable material may also be utilized.

In the illustrated example, each retainer clip 18 (FIG. 4) includes a flexibly resilient U-shaped portion 38, a leg portion extending from the U-shaped portion 38 and cooperating with the U-shaped portion 38 to form an S-shape, and an engagement portion 42 extending substantially orthogonally from the leg portion 40. The U-shaped portion 38 includes a plurality of inwardly-extending barbs 44, and an inwardly-turned tab 46 extending from an end thereof. The leg portion 40 is flexibly resilient along the length thereof. The engagement portion 42 includes an arcuately-shaped, outwardly-turned, curved lip 48 located at a distal end thereof. The lip 48 forms an engagement surface 50 for frictionally engaging an associated wheel lug nut 30, as described below.

In assembly, as best illustrated in FIG. 5, the U-shaped portion 38 of each retainer clip 18 is pressed onto the inner wall 34 of an associated sleeve 32 in a direction as indicated by directional arrow 52, thereby causing the U-shaped portion 38 to flex in a direction as indicated by directional arrow 54 and the barbs 44 of the U-shaped portion 38 to frictionally engage the inner wall 34. As illustrated, once the inner wall 34 is completely received within the U-shaped portion 38, a portion of the U-shaped portion 38 and the leg portion 40 are received within the pocket 35, and the engagement portion 42 is received within the associated notch 29 of the skirt portion 26, such that the distal end of the engagement portion 42 extends outwardly beyond the outer surface 22 of the wheel cover 16.

The wheel cover assembly 14 is assembled with the associated vehicle wheel 12 by aligning the recesses 28 of the skirt portion 26 with the lug nuts 30 and pressing the wheel cover assembly 14 inwardly towards the vehicle wheel 12 in a direction as indicated by directional arrow 56, thereby causing the leg portion 40 of each retainer clip 18 to flex in a direction as indicated by directional arrow 58 as the lip 48 guides over an enlarged portion 60 of each lug nut 30 until the engagement surface 50 of the lip 48 engages a tapered conical portion 62 of each lug nut 30.

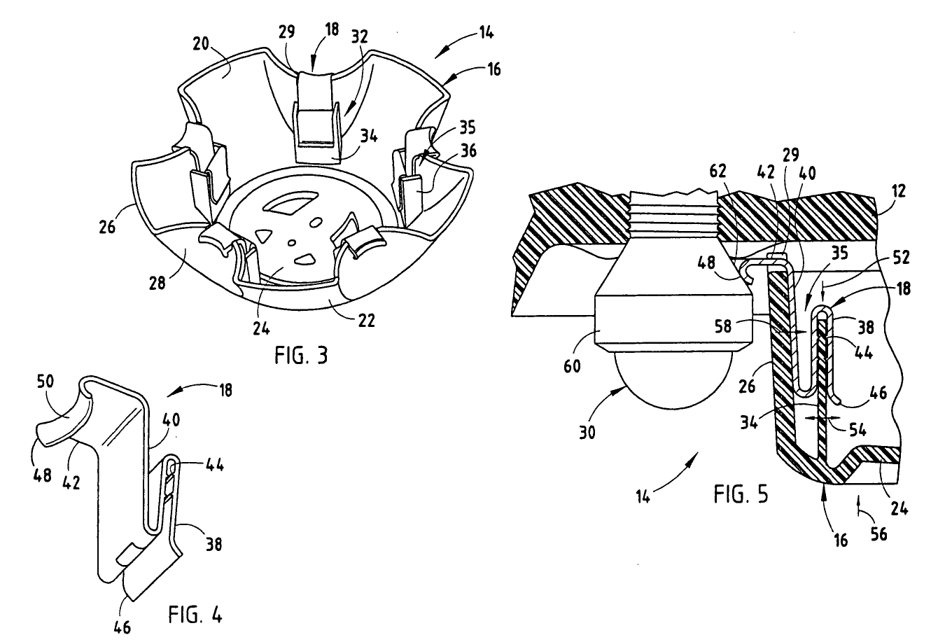

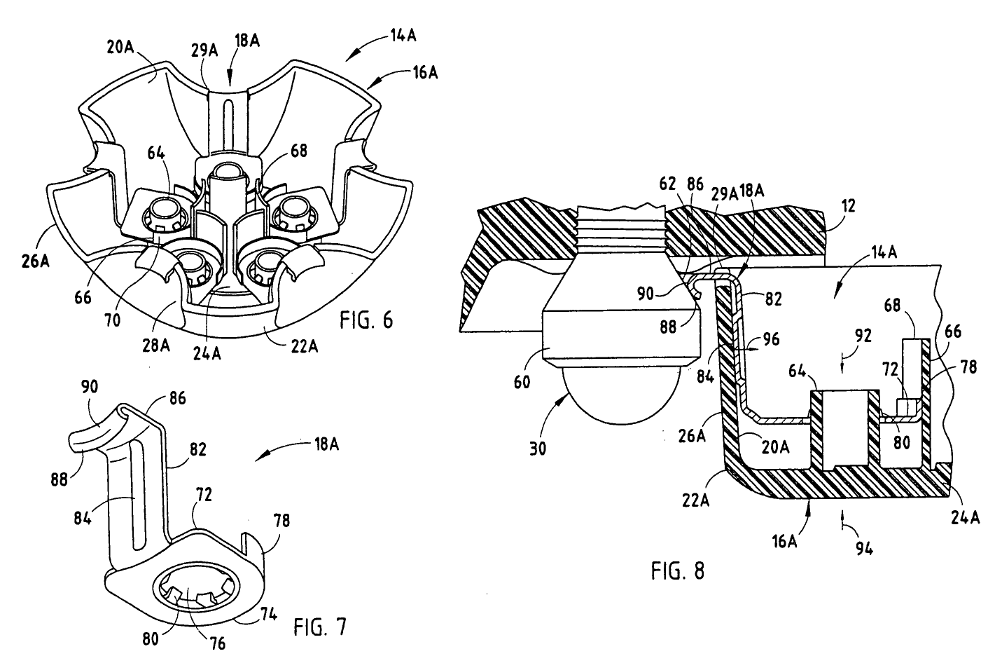

The reference numeral 14A (FIG. 6) generally designates another embodiment of the wheel cover assembly embodying the present invention. Since the wheel cover assembly 14A is similar to the previously-described wheel cover assembly 14, similar parts appearing in FIGS. 3-5 and FIGS. 6-8, respectively, are represented by the same, corresponding reference numeral, except for the suffix “A” in the numerals of the latter. The wheel cover assembly 14A includes a plurality of bosses 64 each extending inwardly from the body portion 24A of the wheel covers 16A and circumferentially spaced thereabout so as to be aligned with the recesses 28A. A plurality of arcuately-shaped sleeves are concentrically located about the bosses 64. Each sleeve 66 includes a center portion 68 extending a first distance from the body portion 24A, and a pair of side portions 70 extending a second distance from the body portion 24A that is less than the first distance of the center portion 68.

Each retainer clip 18A (FIG. 7) includes a planar body portion 72 having an arcuately-shaped proximal end 74 and a centrally-located, circularly-shaped aperture 76 extending therethrough. A collar 78 extends orthogonally inward from the proximate end 74 about the arc thereof. The aperture 76 includes a plurality of tabs 80 spaced circumferentially about the circumference of the aperture 76. Each retainer clip 18A also includes a leg portion 82 extending from the body portion 72 and including an outwardly-extending shoulder 84 extending along the length of the leg portion 82. Each retainer clip 18A further includes an engagement portion 86 extending from the leg portion 82 and including an outwardly curled lip 88 defining an arcuately-shaped engagement surface 90.

In assembly, each retainer clip 18A is coupled with an associated boss 64 by aligning the aperture 76 of the body portion 72 with the associated boss 64 and pressing the retainer clip 18A outwardly in a direction as indicated by directional arrow 92, thereby engaging the boss 64 within the aperture 76 such that the tabs 80 of the aperture 76 frictionally engage the boss 64 and the engagement portion 86 is received within an associated notch 29A. and the collar 78 guides along the sleeve 66. The wheel cover assembly 14A is coupled with the wheel 12 by aligning the recesses 28A of the skirt portion 26A with the lug nuts 30 that retain the wheel 12 to the associated vehicle. A force in the direction and as represented by directional arrow 94 is then exerted on the cover assembly 14A, thereby causing the leg portion 82 of each retainer clip 18A to flex inwardly in a direction as indicated by directional arrow 96 as the lip 88 of each retainer clip 18A guides over the enlarged portion 60 of each lug nut 30 until the engagement surface 90 of each retainer clip 18A abuts the conical portion 62 of the associated lug nut 30 and the shoulder 84 of the associated leg portion 82 abuts the inner surface 20A of the wheel cover 16A.

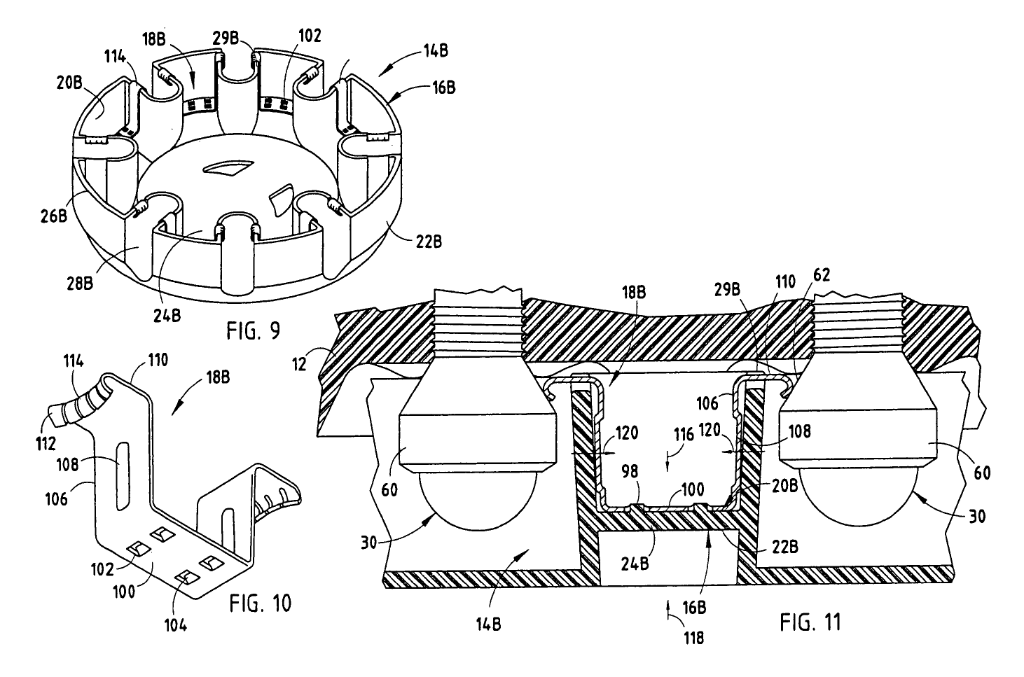

The reference number 14B (FIG. 9) generally designates another embodiment of the wheel cover assembly. Since the cover assembly 14B is similar to the previously described cover assembly 14, similar parts appearing in FIGS. 3-5 and FIGS. 9-11, respectively, are represented by the same, corresponding reference numeral, except for the suffix “B” in the numerals of the latter. The wheel cover 16B of the cover assembly 14B includes a plurality of locking tabs or bosses 98 interspaced between the recesses 28B of the skirt portion 26B. In the illustrated example, a grouping of four tabs 98 are located between each pair of recesses 28.

Each retainer clip 18B includes a planar body portion 100 having four square-shaped apertures extending therethrough, although other numbers of apertures may be utilized. Each aperture includes a pair of inwardly-extending tabs 104 opposed across the associated aperture 102 from one another. Each retainer clip 18B also includes a pair of leg portions 106 extending from the body portion 100 and opposed across the body portion 100 from one another. Each leg portion 106 includes an outwardly-extending shoulder 108 extending longitudinally along the length of the associated leg portion 106. Each leg portion 106 extends into an engagement portion 110, each having an outwardly-extending lip 112 having an arcuately-shaped engagement surface 114.

In assembly, each retainer clip 18B is coupled with the wheel cover 16B by aligning the apertures 102 of the body portion 100 with the associated tabs 98 and pressing the retainer clip 18B outwardly in a direction as indicated by directional arrow 116, thereby forcing the tabs 98 into the apertures 102, such that the tabs 98 are frictionally engaged by the tabs 104 of the retainer clip 18B, and the engagement portions 110 of the retainer clip 18B are received within the notches 29B of the wheel cover 16B. The cover assembly 14B is coupled with the wheel 12 by aligning the recesses 28B with the lug nuts 30 and exerting an inwardly-directed force as indicted by directional arrow 118 to the cover assembly 14B, thereby causing the leg portions 106 of the retainer clip 18B to flex in a direction as indicated by directional arrows 120 as the lips 112 of the engagement portions 110 guide over the enlarged portions 60 of the lug nuts 30 until the engagement surfaces 114 of the engagement portions 110 abut the conical portions 62 of the lug nuts 30, and the shoulder 108 of each leg portion 106 abuts the inner surface 20B of the skirt portion 26B.

The retention clip as disclosed and described herein is useable between a variety of wheel cover and vehicle wheel configurations, and is useable with wheel cover configurations that allow access to lug nuts as associated with the vehicle wheel subsequent to the wheel cover being coupled with the vehicle wheel. The retention clip as disclosed herein reduces manufacturing costs as associated with the necessity for manufacturing retention clips of various designs in order to adequately retain wheel covers with vehicle wheels each having varying configurations. The retention clip may be assembled with the associated wheel coverings without the requirement of complicated or specialized tools, may be easily and quickly assembled by even unskilled personnel, is capable of a long operating life, and is particularly well adapted for the proposed use.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A wheel cover assembly, comprising:
a cover member having an inner surface, an outer surface, a body portion, and a skirt portion extending inwardly from and circumferentially about the body portion, and at least one inner wall extending inwardly from the skirt portion and spaced therefrom; and
at least one retention clip operably coupled with the cover member and having a flexibly resilient U-shaped portion that frictionally engages the inner wall, thereby coupling the at least one retention clip with the cover member, a leg portion that abuts the inner surface of the skirt portion along a length of the leg portion, and an engagement portion extending outwardly from the leg portion and that is adapted to abut a lug nut of a wheel assembly, thereby releasably coupling the wheel cover assembly with the wheel assembly.

2. The wheel cover assembly of claim 1, wherein the U-shaped portion of the at least one retention clip includes at least one barb located along the length thereof, and wherein the barb engages the inner wall of the cover member, thereby inhibiting uncoupling of the at least one retention clip with the cover member.

3. The wheel cover assembly of claim 2, wherein the engagement portion of the at least one retention clip is flexibly resilient.

4. The wheel cover assembly of claim 3, wherein the engagement portion of the at least one retention clip includes an arcuately-shaped proximal end.

5. The wheel cover assembly of claim 4, wherein the proximal end of the engagement portion includes an outwardly curved lip.

6. The wheel cover assembly of claim 5, wherein the U-shaped portion and leg portion of the at least one retention clip cooperate to form an S-shape.

7. The wheel cover assembly of claim 1, wherein the cover member is configured such that each lug nut of the wheel assembly is exposed when cover member is coupled with the wheel assembly.

8. The wheel cover assembly of claim 1, wherein the at least one retention clip includes a plurality of spaced apart retention clips spaced circumferentially about the cover member.

9. A retention clip for a vehicle wheel cover member, comprising:
a flexibly resilient U-shaped portion adapted to engage a wall of a vehicle wheel cover member;
a leg portion extending from the U-shaped portion and cooperating with the U-shaped portion to form an S-shape, wherein the leg portion is adapted to abut the cover member along a length of the leg portion when the retention clip is operably coupled with the cover member; and
a engagement portion extending from the leg portion, and adapted to engage a vehicle wheel, thereby coupling the cover member with the vehicle wheel.

10. The retention clip of claim 9, wherein the engagement portion is adapted to engage a lug nut of the vehicle wheel.

11. The retention clip of claim 10, wherein the engagement portion is adapted to engage a conical surface of the lug nut that is not seated within a lug well of the vehicle wheel when the vehicle wheel is installed on an associated vehicle.

12. The retention clip of claim 11, wherein the engagement portion is arcuately shaped.

13. The retention clip of claim 12, wherein the engagement portion includes an outwardly curved lip.

14. The retention clip of claim 10, wherein the engagement portion is flexibly resilient.

15. The retention clip of claim 19, wherein the U-shaped portion includes at least one barb along the length thereof, and wherein the barb is adapted to engage a portion of the wheel cover, thereby inhibiting uncoupling of the retention clip from the wheel cover.

16. A wheel cover assembly, comprising:
a cover member having an inner surface, an outer surface, a body portion, and a skirt portion extending inwardly from and circumferentially about the body portion; and
at least one retention clip operably coupled with the cover member and having a leg portion and an engagement portion extending outwardly from the leg portion, wherein the leg portion abuts the inner surface of the skirt portion for a distance along a length of the leg portion, and wherein the engagement portion is adapted to abut a lug nut of a wheel assembly, thereby releasably coupling the wheel cover assembly with the wheel assembly.
